(19) United States
(12) Patent Application Publication
(10) Pub. No.: US 2018/0357581 A1
(43) Pub. Date: Dec. 13, 2018

(54) Operation Risk Summary (ORS)

(71) Applicant: HCL Technologies Limited, Noida (IN)

(72) Inventors: Sandeep SHARMA, Noida (IN); Nidhi Narang SACHDEVA, Noida (IN); Deepak BOSE, Noida (IN)

(21) Appl. No.: 15/713,434

(22) Filed: Sep. 22, 2017

(30) Foreign Application Priority Data
Jun. 8, 2017 (IN) 201711020148

(51) Int. Cl. G06Q 10/06

(52) U.S. Cl. CPC G06Q 10/0635; G06T 11/206

(57) ABSTRACT

Disclosed is a system for indicating an operational risk profile of an organization. A data receiving module 212 receives an input data corresponding to a set of parameters associated with an operational risk profile of an organization. A data computation module 214 computes a risk profile value corresponding to each parameter. An assignment module 216 assigns a risk profiling score to the parameter based on comparison of a predefined baseline target value and the risk profile value. Further, the data computation module 214 aggregates the risk profiling score assigned to each parameter in order to derive an aggregated risk profiling score for a predefined time interval. An identification module 216 identifies a category, amongst a plurality of predefined categories, based on the aggregated risk profiling score and a predefined range associated with each category indicating a distinct operational risk profile of the organization.

### PRIORITY INFORMATION

This patent application claims priority from Indian Application No. 201711020148 filed on 8, Jun. 2017, the entirety of which is hereby incorporated by reference.

### TECHNICAL FIELD

The present subject matter described herein, in general, relates to operational risk associated with an organization and more particularly to indicating an operational risk profile of the organization.

### BACKGROUND

In an era of industrialization, it is a paramount concern for every organization to reduce risks and costs associated with operations of the organization. In order to make profitable business proposition, every organization refers to yearly forecasts and projections data provided by an audit team of the organization. However, the yearly forecasts and the projections data changes periodically. Now, apart from the yearly forecasts and the projections data, organizations have a renewed focus which is to manage risk. Risk is the main cause of uncertainty in any organization. Thus, every organization is increasingly focusing and allocating more resources on identifying and managing risks before the risks affect the overall business. The ability to manage risk helps the organization act more confidently on future business decisions.

In general, when the risk associated with an operation is identified, an issue related to the risk is reported to a senior management of the organization. Currently, the issue is reported with a minimum delay of 720 hours to the senior management. Thus, the senior management may take several months of further delay to take action against the issue related to the risk. In order to reduce the time taken by the senior management to act on the issue, it is vital to device a system to raise flags/pre-warnings for any operation by analyzing the pattern/trends of the existing yearly forecast and projection data. It has been observed that specific skill set and competency of team members are key to achieving milestones in every operation of the organization Planning and assigning of any specific task to an individual or a team completely depends upon the specific skill set and competency. If ignored, it may lead to a violation of a Service Level Agreement (SLA) with the customer which in-turn affects the key quality metrics such as severity 1 resolution, On Time Delivery (OTD), First Time Right (FTR), etc. and thereby affects the relationship with the customer. This may lead to customer losing the trust on the service provider that could eventually a loss of business opportunity.

### SUMMARY

Before the present systems and methods, are described, it is to be understood that this application is not limited to the particular systems, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is provided to introduce concepts related to systems and methods for indicating an operational risk profile of an organization and the concepts are further described below in the detailed description. This summary is not intended to identify essential features of the claimed subject matter nor is it intended for use in determining or limiting the scope of the claimed subject matter.

In one implementation, a method for indicating an operational risk profile of an organization is disclosed. In order to indicate the operational risk profile of the organization, initially, an input data may be received corresponding to a set of parameters associated with the operational risk profile of the organization. Upon receiving the input data, a risk profile value may be computed corresponding to each parameter. In one aspect, the risk profile may be computed based on a type of a parameter, of the set of parameters, and the input data pertaining to the parameter. Subsequent to the computation of the risk profile value, a risk profiling score may be assigned to the parameter based on comparison of a predefined baseline target value and the risk profile value. Furthermore, the risk profiling score assigned to each parameter may be aggregated in order to derive an aggregated risk profiling score for the set of parameters. In one aspect, the risk profiling score may be aggregated for a predefined time interval. Further to aggregating the risk profiling score assigned to each parameter, a category, amongst a plurality of predefined categories, may be identified based on the aggregated risk profiling score and a predefined range associated with each category. In one aspect, each category may indicate a distinct operational risk profile of the organization. In another aspect, the aforementioned method for indicating the operational risk profile of the organization may be performed by a processor using programmed instructions stored in a memory.

In another implementation, a system for indicating an operational risk profile of an organization is disclosed. The system may comprise a processor and a memory coupled to the processor. The processor may execute a plurality of modules present in the memory. The plurality of modules may comprise a data receiving module, a data computation module, an assignment module, and an identification module. The data receiving module may receive an input data corresponding to set of parameters associated with the operational risk profile of the organization. The data computation module may compute a risk profile value corresponding to each parameter. In one aspect, the risk profile value may be computed based on a type of a parameter, of the set of parameters, and the input data pertaining to the parameter. The assignment module may assign a risk profiling score to the parameter based on comparison of a predefined baseline target value and the risk profile value. Subsequent to assigning the risk profiling score, the data computation module may aggregate the risk profiling score assigned to each parameter in order to derive an aggregated risk profiling score. In one aspect, the risk profiling score may be aggregated for a predefined time interval. The identification module may identify a category, amongst a plurality of predefined categories, based on the aggregated risk profiling score and a predefined range associated with each category. In one aspect, each category may indicate a distinct operational risk profile of the organization.

In yet another implementation, non-transitory computer readable medium embodying a program executable in a computing device for indicating an operational risk profile of an organization is disclosed. The program may comprise a program code for receiving an input data corresponding to set of parameters associated with the operational risk profile of the organization. The program may further comprise a program code for computing a risk profile value corresponding to each parameter. In one aspect, the risk profile value may be computed based on a type of a parameter, of the set of parameters, and the input data pertaining to the parameter. The program may further comprise a program code for assigning a risk profiling score to the parameter based on comparison of a predefined baseline target value and the risk profile value. The program may further comprise a program code for aggregating the risk profiling score assigned to each parameter in order to derive an aggregated risk profiling score. In one aspect, the risk profiling score may be aggregated for a predefined time interval. The program may further comprise a program code for identifying a category, amongst a plurality of predefined categories, based on the aggregated risk profiling score and a predefined range associated with each category. In one aspect, each category may indicate a distinct operational risk profile of the organization.

### BRIEF DESCRIPTION OF THE DRAWINGS

The foregoing detailed description of embodiments is better understood when read in conjunction with the appended drawings. For the purpose of illustrating the disclosure, example constructions of the disclosure are shown in the present document; however, the disclosure is not limited to the specific methods and apparatus disclosed in the document and the drawings.

The detailed description is given with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for indicating an operational risk profile of an organization, in accordance with an embodiment of the present subject matter.

FIG. 2 illustrates the system, in accordance with an embodiment of the present subject matter.

FIG. 3 illustrates an operational risk summary (monthly) of the organization.

FIG. 4 illustrates risk trend of the organization.

FIG. 5 illustrates a method for indicating an operational risk profile of an organization, in accordance with an embodiment of the present subject matter.

### DETAILED DESCRIPTION

Some embodiments of this disclosure, illustrating all its features, will now be discussed in detail. The words “receiving,” “computing,” “assigning,” “aggregating,” “identifying,” and “visualizing,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

The present invention indicates an operational risk profile of an organization. It is to be noted that a risk may be caused by any internal and external sources. The risk caused by external sources are those that are not in direct control of a senior management of the organization. Example of the risk caused by external sources include political issues, exchange rates, interest rates, and others. On the other hand, the risk caused by internal sources include non-compliance, information breaches, Service Level Agreement (SLA) breaches and operational risk among others.

It may be noted that the operational risk profile of the organization indicates an overall risk factor associated with the organization. In one aspect, the operational risk profile may indicate the overall risk factor associated with an operation, an account, a Delivery Unit (DU), a Regional Delivery Unit (RDU) and alike. It may also be noted that by analyzing the operational risk profile of the organization, risk associated with an individual operation may also be computed. The individual operation with higher risk may be identified and reported to the senior management of the organization in order to take precautionary measures against the risk. To do so, the operational risk profile of the organization may be computed based on a plurality of parameters. The plurality of parameters may include, but not limited to, a Service Level Agreements (SLAs) comprising financials and non-financials, a severity 1 resolution on time, an incorrect assignation, a backlog index, a back-up failure, a failed change, a human error, a customer complaint and Ops.Hi5.

It may be understood that the operational risk profile is an evaluation of an individual or organization's willingness to take risks and threats to which an organization may be exposed. The operational risk profile may be used as a way to mitigate potential risks and threats. The operational risk profile is important for determining an appropriate investment of asset allocation for a portfolio. Furthermore, the operational risk profile may capture existing data of operations health and delivery effectiveness and other related metrics over a period of one year/one month across all operational accounts of the organization. Subsequent to capturing of the existing data, the operational account may be compared with current performance of the organization to determine risk associated with the operational account. Also the operational risk profile may be configured to generate Risk Summary (RS) of the organization based on performances of one or more operational accounts. It is to be noted that the operational risk profile may serve as an early warning for the operational accounts to lower the risks.

In one embodiment, the operational risk profile may highlight the risks/pre-warnings at various levels including, but not limited to, a Service Delivery Manager (SDM), a Delivery Unit (DU), a Regional Delivery Unit (RDU). Further, the operational risk profile may be exported in a report format. In one embodiment, the operational risk profile may also be displayed on a dashboard of a mobile application or a web application enabling real time monitoring of the operational risk profile. While aspects of described system and method for indicating an operational risk profile of an organization and may be implemented in any number of different computing systems, environments, and/or configurations, the embodiments are described in the context of the following exemplary system.

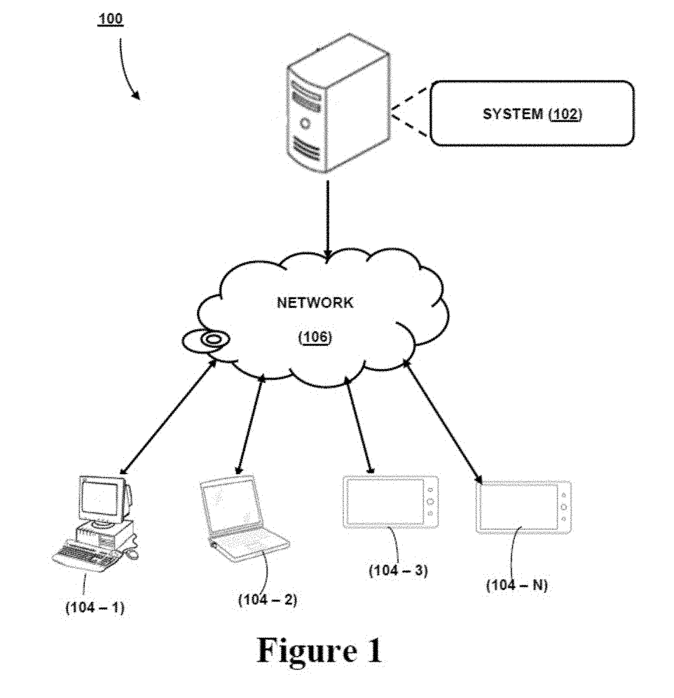

Referring now to FIG. 1, a network implementation 100 of a system 102 for indicating an operational risk profile of an organization is disclosed. In order to indicate an operational risk profile of an organization, initially, the system 102 may receive an input data corresponding to a set of parameters associated with an operational risk profile of an organization. Upon receiving the input data, the system 102 may compute a risk profile value corresponding to each parameter. In one aspect, the risk profile may be computed based on a type of a parameter, of the set of parameters, and the input data pertaining to the parameter. Subsequent to the computation of the risk profile value, the system 102 may assign a risk profiling score to the parameter based on comparison of a predefined baseline target value and the risk profile value. Furthermore, the system 102 may aggregate the risk profiling score assigned to each parameter, in order to derive an aggregated risk profiling score for the set of parameters. In one aspect, the risk profiling score may be aggregated for a predefined time interval. Further to aggregating the risk profiling score assigned to each parameter, the system 102 may identify a category, amongst a plurality of predefined categories, based on the aggregated risk profiling score and a predefined range associated with each category. In one aspect, each category may indicate a distinct operational risk profile of the organization.

Although the present disclosure is explained considering that the system 102 is implemented on a server, it may be understood that the system 102 may be implemented in a variety of computing systems, such as a laptop computer, a desktop computer, a notebook, a workstation, a mainframe computer, a server, a network server, a cloud-based computing environment. It will be understood that the system 102 may be accessed by multiple users through one or more user devices 104-1, 104-2 . . . 104-N, collectively referred to as user 104 or stakeholders, hereinafter, or applications residing on the user devices 104. In one implementation, the system 102 may comprise the cloud-based computing environment in which a user may operate individual computing systems configured to execute remotely located applications. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

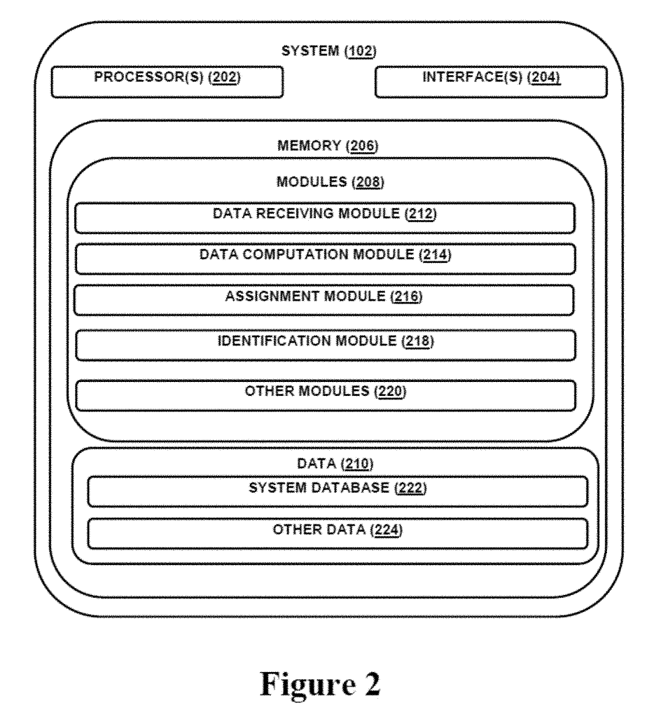

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a data receiving module 212, a data computation module 214, an assignment module 216, an identification module 218, and other modules 220. The other modules 220 may include programs or coded instructions that supplement applications and functions of the system 102. The modules 208 described herein may be implemented as software modules that may be executed in the cloud-based computing environment of the system 102.

The data 210, amongst other things, serves as a repository for storing data processed, received, and generated by one or more of the modules 208. The data 210 may also include a system database 222 and other data 224. The other data 224 may include data generated as a result of the execution of one or more modules in the other modules 220.

As there are various challenges observed in the existing art, the challenges necessitate the need to build the system 102 for indicating an operational risk profile of an organization. In order to indicate an operational risk profile of an organization, at first, a user may use the client device 104 to access the system 102 via the I/O interface 204. The user may register them using the I/O interface 204 in order to use the system 102. In one aspect, the user may access the I/O interface 204 of the system 102. The system 102 may employ the data receiving module 212, the data computation module 214, the assignment module 216, and the identification module 218. The detail functioning of the modules is described below with the help of figures.

The present system 102 indicates an operational risk profile of an organization. To do so, initially, the data receiving module 212 receives an input data corresponding to set of parameters associated with an operational risk profile of an organization. It may be noted that the input data may comprise a first input and a second input. In one aspect, the first input may be a numerator of metric of a parameter, of the set of parameters, under consideration. Similarly, the second input may be a denominator of metric of a parameter, of the set of parameters, under consideration. Examples of the set of parameters may include, but not limited to, a Service Level Agreements (SLAs) comprising financials and non-financials, a severity 1 resolution on time, an incorrect assignation, a backlog index, a back-up failure, a failed change, a human error, a customer complaint and Operations Health Index for 5 categories (Ops.Hi5). In one embodiment, the data receiving module 212 may receive an input data from one or more audit system, customer feedback portal, delivery tracking system, and others.

Subsequent to receiving the input data, the data computation module 214 computes a risk profile value corresponding to each parameter. In one aspect, the risk profile value may be computed based on a type of a parameter, of the set of parameters, and the input data pertaining to the parameter. It may be understood that the data computation module 214 may compute the risk profile value corresponding to each parameter on a weekly, a monthly or a yearly basis. In one example, met SLA comprising non-financials, of the set of parameters, may be computed by using a below formulation:

$$Met SLA comprising non \text{-} financials = ( 1 - \frac{first input}{second input} ) * 100 \% \qquad ( 1 )$$

As described in equation (1), the data computation module 214 computes the met SLA comprising non-financials based on a plurality of parameters such as “first input” and “second input” The first input may comprise a total number of SLA and Key Process Identifier (KPI) missed. The second input may comprise a total number of assigned SLA and KPI. It may be noted that the met SLA comprising non-financials is denoted in percentage.

In one example, met SLA comprising financials may be computed by using a below formulation:

$$Met SLA comprising financials = ( 1 - \frac{first input}{second input} ) * 100 \% \qquad ( 2 )$$

As described in equation (2), the data computation module 214 computes the met SLA comprising financials based on a plurality of parameters such as the “first input” and the “second input”. The first input may comprise a total number of SLA and KPI missed. The second input may comprise a total number of assigned SLA and KPI. It may be noted that the met SLA comprising financials is denoted in percentage.

In one example, the severity 1 resolution (hereinafter may also be referred as sev1 resolution) on time may be computed by using a below formulation:

$$Sev 1 resolution on time = ( \frac{first input}{second input} * 100 ) \% \qquad ( 3 )$$

As described in equation (3), the data computation module 214 computes the sev1 resolution on time based on a plurality of parameters such as the “first input” and the “second input”. The first input may comprise a number of severity 1 incidents resolved within target during a stipulated time. The second input may comprise a total severity 1 incidents resolved within target during the stipulated time. The sev1 resolution on time indicates whether a query is resolved within the stipulated time frame or not. In one aspect, the query may comprise one or more of a customer issues, internal issues, deployment issue, business related issues, development related issues and Human Resource Management (HRM) related issues. It may be noted that the sev1 resolution on time is denoted in percentage.

In one example, the incorrect assignation may be computed by using a below formulation:

$$Incorrect assignation = ( \frac{first input}{second input} * 100 ) \% \qquad ( 4 )$$

As described in equation (4), the data computation module 214 computes the incorrect assignation based on a plurality of parameters such as the “first input” and the “second input”. The first input may comprise a number of incidents assigned to wrong group or person during the stipulated time. The second input may comprise a total of incidents created during the stipulated time. The incorrect assignation indicates number of incidents when the query is assigned to an incorrect resource in the organization. It may be noted that the incorrect assignation is denoted in percentage.

In one example, the backlog index may be computed by using a below formulation:

$$Backlog index = ( \frac{first input}{second input} * 100 ) \% \qquad ( 5 )$$

As described in equation (5), the data computation module 214 computes the backlog index based on a plurality of parameters such as the “first input” and the “second input”. The first input may comprise total number of incidents that are outstanding and missed the SLA target during performance period. The second input may comprise a total number of incidents during the performance period. The backlog index may indicate number of unresolved incidents from operations performed in past. It may be noted that the backlog index is denoted in percentage.

In one example, the back-up failures may be computed by using a below formulation:

$$Back \text{-} up failures = ( \frac{first input}{second input} * 100 ) \% \qquad ( 6 )$$

As described ion equation (6), the data computation module 214 computes the back-up failures based on a plurality of parameters such as the “first input” and the “second input”. The first input may comprise a number of job/script/backups failed during the stipulated time. The second input may comprise a total of Job/Script/backups scheduled for completion during the stipulated time. In one aspect, the back-up failures may be replaced by a number of job pending/number of scripts pending. It may be understood that the data computation module 214 may compute the number of job pending/number of scripts pending based on a plurality of parameters such as the “first input” and the “second input”. It may be noted that the back-up failures/number of job pending/number of script pending is denoted in percentage.

In one example, the failed change may be computed by using a below formulation:

$$Failed change = ( \frac{first input}{second input} * 100 ) \% \qquad ( 7 )$$

As described in equation (7), the data computation module 214 computes the failed change based on a plurality of parameters such as the “first input” and the “second input”. The first input may comprise a number of failed changes during the stipulated time. The second input may comprise a total number of approved changes during the stipulated time. The failed change may indicate a number of incident when a change requested by a customer is not implemented. It may be noted that the failed change is denoted in percentage.

In one example, the data computation module 214 computes the risk profile value associated with the human error based on number of incidences when an error associated with a human is reported to the system 102. When the error associated with the human is reported the data computation module 214 may assign the risk profile value as ‘10’. On the other hand, when the error associated with the human is not reported, the data computation module 214 may assign the risk profile value as ‘0’. It may be noted that the SLA comprising non-financials is denoted in percentage.

In one example, customer complaints closed/followed-up may be computed by using a below formulation:

$$Customer complaints closed \text{/} followed \text{-} up - ( \frac{first input}{second input} * 100 \% ) \qquad ( 8 )$$

As described in equation (8), the data computation module 214 computes the customer complaints closed/followed-up based on a plurality of parameters such as the “first input” and the “second input”. The first input may comprise a number of customer complaints closed/followed-up during the stipulated time. The second input may comprise a total number of customer complaints registered during the stipulated time. It may be noted that the customer complaints closed/followed-up is denoted in percentage.

In one example, the data computation module 214 computes the Operations Health Index for 5 categories (Ops.Hi5) based on reporting of one or more parameters, of the set of parameters, in red/amber region. The categories include service delivery, people, financial, internal compliance and internal support. It is to be noted that Operation Health Index, in general, comprise 112 distinct parameters marked as critical and important.

Further to the computation of the risk profile value corresponding to each parameter, the assignment module 216 may assign a risk profiling score to the parameter based on comparison of a predefined baseline target value and the risk profile value. It may be understood that the predefined baseline target indicates a threshold value for the parameter. In one embodiment, the assignment module 216 may assign the risk profiling score, on a scale of ‘0’ to ‘10’, to the parameter based on a scoring scale. It may be noted that the risk profiling score as ‘0’ is a least vulnerable score and ‘10’ is most vulnerable score associated with the parameters. It may also be understood that the scoring scale of one parameter may be different from the scoring scale of other parameter. In one embodiment, the assignment module 216 may assign the risk profiling score based on comparison of the predefined baseline target value and the scoring scale for the set of parameters as per the below table 1.

| | | Baseline | |
|---|---|---|---|
| Sr. No. | Parameter | Target | Scoring Scale |
| 1 | Met SLA | 90% | Less than 90 gets 10 |
| | (Non-Financial) | | 90 and less than 92 gets 8 |
| | | | 92 and less than 94 gets 6 |
| | | | 94 and less than 96 gets 4 |
| | | | 96 and less than 98 gets 2 |
| | | | 98 to less than 100 gets 1 |
| | | | At 100 gets 0 |
| 2 | Met SLA | 100% | Less than 100% gets 10 |
| | (Financial) | | At 100 gets 0 |
| 3 | Sev1 Resolution | 95% | Less than 95 gets 10 |
| | on time | | 95 and less than 96 gets 8 |
| | | | 96 and less than 97 gets 6 |
| | | | 97 and less than 98 gets 4 |
| | | | 98 and less than 99 gets 2 |
| | | | 99 to less than 100 gets 1 |
| | | | At 100 gets 0 |
| 4 | Incorrect | 5% | Greater than 5 gets 10 |
| | Assignation | | 5 and greater than 4 gets 8 |
| | | | 4 and greater than 3 gets 6 |
| | | | 3 and greater than 2 gets 4 |
| | | | 2 and greater than 1 gets 2 |
| | | | 1 and greater than 0 gets 1 |
| | | | At 0 gets 0 |
| 5 | Backlog Index | 5% | Greater than 5 gets 10 |
| | | | 5 and greater than 4 gets 8 |
| | | | 4 and greater than 3 gets 6 |
| | | | 3 and greater than 2 gets 4 |
| | | | 2 and greater than 1 gets 2 |
| | | | 1 and greater than 0 gets 1 |
| | | | At 0 gets 0 |
| 6 | Back-Up Failures/ | 5% | Greater than 5 gets 10 |
| | Number of job | | 5 and greater than 4 gets 8 |
| | pending/Number | | 4 and greater than 3 gets 6 |
| | of scripts pending | | 3 and greater than 2 gets 4 |
| | | | 2 and greater than 1 gets 2 |
| | | | 1 and greater than 0 gets 1 |
| | | | At 0 gets 0 |
| 7 | Failed Change | 5% | Greater than 5 gets 10 |
| | | | 5 and greater than 4 gets 8 |
| | | | 4 and greater than 3 gets 6 |
| | | | 3 and greater than 2 gets 4 |
| | | | 2 and greater than 1 gets 2 |
| | | | 1 and greater than 0 gets 1 |
| | | | At 0 gets 0 |
| 8 | Human Error | 0 count | Greater than 0 gets 10 |
| | | | At 0 gets 0 |
| 9 | Customer | 95% | Less than 95 gets 10 |
| | Complaints | | 95 and less than 96 gets 8 |
| | Closed/ | | 96 and less than 97 gets 6 |
| | Followed-Up | | 97 and less than 98 gets 4 |
| | | | 98 and less than 99 gets 2 |
| | | | 99 to less than 100 gets 1 |
| | | | At 100 gets 0 |
| 10 | OPS Hi 5 | 10 Count | Greater than 10 gets 10 |
| | | | 8 to 10 gets 8 |
| | | | 6 and 7 gets 6 |
| | | | 4 and 5 gets 4 |
| | | | 2 and 3 gets 2 |
| | | | At 1 gets 1 |
| | | | At 0 gets 0 |

In another embodiment, the assignment module 216 may further assign a color to the risk profiling score assigned to each parameter. It may be understood that the risk profiling score assigned to each parameter may be mapped with the color, of plurality of colors, present in a predefined color code scheme. The predefined color code scheme comprises colors from a gradient scale of red, amber and green color. In one example, the risk profiling score as ‘0’, ‘1’, and ‘2’ may be mapped with the gradient scale of green color. Furthermore, the risk profiling score as ‘3’ and ‘4’ may be mapped with the gradient scale of amber color. Similarly, the risk profiling score as ‘5’, ‘6’, ‘7’, ‘8’, ‘9’, and ‘10’ may be mapped with the gradient scale of red color. It may also be noted that the green color indicates low risk, while the red color indicates high risk associated with the parameter.

Subsequent to the assignment of the risk profile score to each parameter, the data computation module 214 aggregates the risk profiling score assigned to each parameter in order to derive an aggregated risk profiling score. In one aspect, the risk profiling score may be aggregated for a predefined time interval. It may be understood that the aggregated risk profiling score is associated with one or more accounts/departments/groups present in the organization. In another aspect, the predefined time interval may include a week, a fortnight, a month, a quarter, a half-year, a year and others. In one example, the aggregated risk profiling score to the one or more accounts/departments/groups present in the organization may be represented on a scale of ‘0 to 100’.

Subsequent to the aggregation of the risk profiling score, the identification module 218 may identify a category, amongst a plurality of predefined categories, based on the aggregated risk profiling score and a predefined range associated with each category. It may be noted that each category may indicate a distinct operational risk profile of the organization. It may also be noted that the aggregated risk profiling score as ‘0’ may be identified as a safe score. On the other hand, the aggregated risk profiling score as ‘100’ may be identified as a risk score.

In one embodiment, the aggregated risk profiling score may be visualized over an interface by using predefined color code scheme. In one aspect, the predefined color code scheme may be based on the predefined range associated with each category. It may be understood that the predefined color code scheme comprises one or more of gradient colors of green, amber and red color. In one example, the aggregated risk profiling score between 0 to 24.99 may be represented by the gradient colors of green color. Furthermore, the aggregated risk profiling score between 25 to 49.99 may be represented by the gradient colors of amber color. Similarly, the aggregated risk profiling score between 50 to 100 may be represented by the gradient colors of red color. It may be noted that the one or more accounts/departments/groups falling under amber color and red color may be reviewed on a priority by management of the organization.

In another embodiment, the identification module 218 may rank the one or more accounts/departments/groups based on the risk profiling score. Further, the identification module 218 may categorize the one or more accounts/departments/groups as bottom 5, bottom 20, bottom 15, bottom 20 and others.

In one implementation, the system 102 may be configured to generate a report comprising at least one or more parameters including, but not limited to, a first input and a second input corresponding to each parameter, a baseline target for each parameter, a risk profiling value, a risk profiling score corresponding to each parameter, and an aggregated risk profiling score. It may be understood that the report may be generated on a monthly, quarterly or yearly basis.

Now, consider an example of a Year to Month (YTM) report. The YTM comprise one or more of a YTM first input, a YTM second input, a YTM risk profiling value, and a YTM risk profiling score. It may be noted that the first input, the second input, the risk profiling value, and the risk profiling score associated with each parameter, as aforementioned, hereinafter referred to as the YTM first input, the YTM second input, the YTM risk profiling value, and the YTM risk profiling score in this example A snapshot of the YTM report is represented in below table 2.

| | YTM | YTM | YTM risk | YTM risk |
|---|---|---|---|---|
| | First | Second | Profiling | Profiling |
| Parameters | input | input | Value | Score |
| SLA (Non-Financials) | 55 | 431 | 87.2% | 10 |
| SLA (Financials) | 17 | 1812 | 99.1% | 10 |
| Sev1 resolution on time | 45 | 48 | 93.8% | 10 |
| Incorrect assignment | 0 | 18556 | 0% | 0 |
| Backlog Index | 865 | 17442 | 5% | 8 |
| Back-up failures/Number of jobs | 513 | 284312 | 0.2% | 1 |
| pending/Number of script | | | | |
| pending | | | | |
| Change failed | 35 | 1329 | 2.6% | 4 |
| Human Error | — | — | 0 | 0 |
| Customer Complaint closed/ | 0 | 0 | 100% | 0 |
| followed-up | | | | |
| OPS_Hi5 | — | — | 10.3 | 8 |
| Aggregated risk profiling score | | | | 51 |

Now in order to explain table 2 further, consider an example of, the parameter, the SLA (non-financials). The YTM first input of the SLA (non-financials) is ‘55’ and the YTM second input of the SLA (non-financials) is ‘431’. It is to be noted that the YTM first input of the SLA (non-financials) is a cumulative score of the YTM first input corresponding to the SLA (non-financials), over the period of twelve months, as mentioned in below table 3. Similarly, the YTM second input of the SLA (non-financials) is the cumulative score of the YTM second input corresponding to the SLA (non-financials).

Parameter
SLA (Non-Financials)

| | YTM First | YTM Second |
|---|---|---|
| Month | input | input |
| March | 5 | 36 |
| April | 5 | 36 |
| May | 5 | 36 |
| June | 7 | 36 |
| July | 6 | 36 |
| August | 5 | 36 |
| September | 4 | 36 |
| October | 4 | 35 |
| November | 3 | 36 |
| December | 4 | 36 |
| January | 5 | 36 |
| February | 2 | 36 |
| Total | 55 | 431 |

Further to determining the YTM first input and the YTM second input, the YTM risk profiling value is computed by using the aforementioned formulation (1). The YTM risk profiling value corresponding to the SLA (non-financials) is ‘87.2%’. Now, by referring to the table 1, the YTM risk profile score corresponding to the SLA (non-financials) is assigned as ‘10’. As the YTM risk profile score is ‘10’, it may be represented in red color, indicating the most vulnerable parameter Similar to the above example, the YTM first input, the YTM second input, the YTM risk profiling value, and the YTM risk profiling score for other parameters may be computed by referring to the formulations from (2) to (8) and table 1.

Furthermore, the aggregated risk profiling score as ‘51’ which falls in the range of 50-100, is represented in red color, and thus is identified as a risk score. It may also be noted that the risk score represents the likelihood of an account falling in a critical zone. In order to overcome the critical zone, the one or more users of the management may take an action on the one or more parameters highlighted as the most vulnerable or having the YTM risk profile score as ‘10’ or close to ‘10’. It may also be noted that the YTM report may be accessed at varied levels including, but not limited to, a Service Delivery Manager (SDM), a Delivery Unit (DU), a Regional Delivery Unit (RDU).

In another implementation, the system 102 may display the report over a Graphical User Interface (GUI)/dashboard of a mobile application or a web application. In other words, the one or more users from the management of the organization may review the operational risk profile of an organization via the mobile application or the web application. It may be understood that the one or more users may download and share the report from the dashboard. In yet another implementation, the system 102 may be configured to generate alerts based on the risk profiling score of the parameters or the aggregated risk profiling score of the organization.

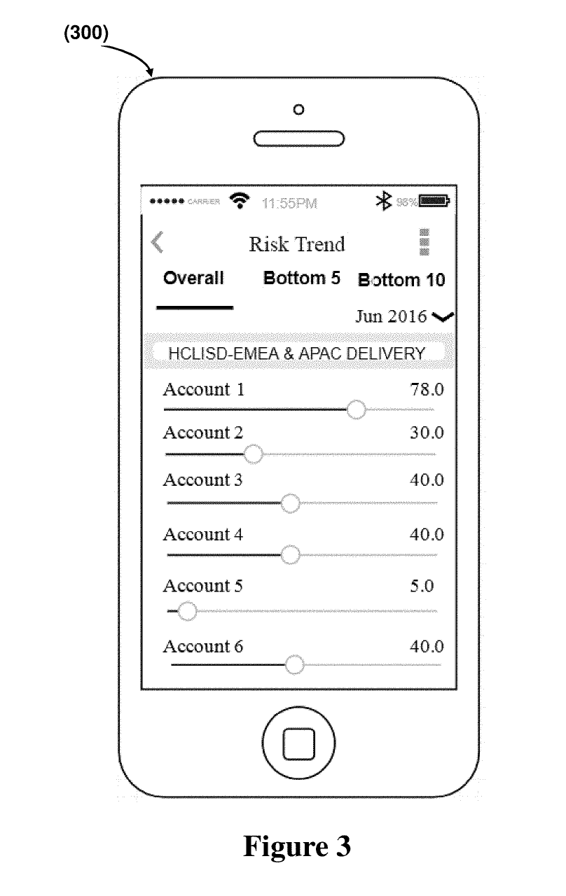

Now referring to FIG. 3, a snapshot 300 for indicating an operational risk summary of an organization is shown, in accordance with an embodiment of the present subject matter. The snapshot 300 represents risk summary, over a period of a month, for the organization comprising one or more different accounts. It may be understood from the snapshot 300 that an account 1 with an aggregated risk profiling score as ‘78’ is a risk score. On the other hand, an account 6 with the aggregated risk profiling score as ‘5’ is a safe score. It may be noted that by using risk summary, over the period of the month, the one or more different accounts may be classified into bottom 5, bottom 10 and others.

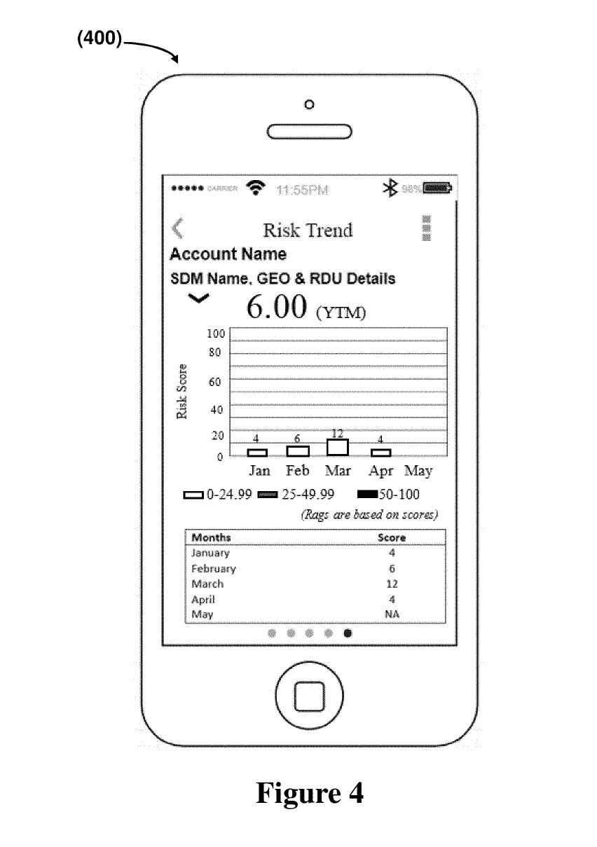

Now referring to FIG. 4, a snapshot 400 for indicating trend of operational risk associated with the organization over several months is shown, in accordance with an embodiment of the present subject matter. It may be understood from the snapshot 400, that the aggregated risk profiling score of the organization is 6 (YTM). Further, the snapshot 400 indicates that the operational risk is highest in the month of March and lowest in the month of May and June.

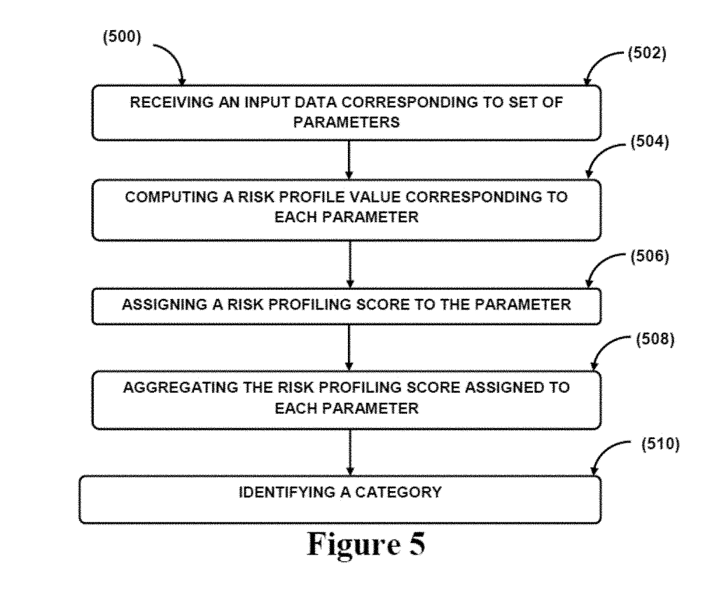

Referring now to FIG. 5, a method 500 for indicating an operational risk profile of an organization is shown, in accordance with an embodiment of the present subject matter. The method 500 may be described in the general context of computer executable instructions. Generally, computer executable instructions can include routines, programs, objects, components, data structures, procedures, modules, functions, etc., that perform particular functions or implement particular abstract data types. The method 500 may also be practiced in a distributed computing environment where functions are performed by remote processing devices that are linked through a communications network. In a distributed computing environment, computer executable instructions may be located in both local and remote computer storage media, including memory storage devices.

The order in which the method 500 is described is not intended to be construed as a limitation, and any number of the described method blocks can be combined in any order to implement the method 500 or alternate methods. Additionally, individual blocks may be deleted from the method 500 without departing from the spirit and scope of the subject matter described herein. Furthermore, the method can be implemented in any suitable hardware, software, firmware, or combination thereof. However, for ease of explanation, in the embodiments described below, the method 500 may be considered to be implemented as described in the system 102.

At block 502, an input data corresponding to set of parameters may be received. In one aspect, the set of parameters associated with an operational risk profile of an organization. In one implementation, the input data corresponding to the set of parameters may be received by a data receiving module 212.

At block 504, a risk profile value corresponding to each parameter may be computed. In one aspect, the risk profile value is computed based on a type of a parameter, of the set of parameters, and the input data pertaining to the parameter. In one implementation, the risk profile value corresponding to each parameter may be computed by a data computation module 214.

At block 506, a risk profiling score may be assigned to the parameter. In one aspect, the risk profiling score may be based on comparison of a predefined baseline target value and the risk profile value. In one implementation, the risk profiling score may be assigned to the parameter by an assignment module 216.

At block 508, the risk profiling score assigned to each parameter may be aggregated. In one aspect, the risk profiling score may be aggregated for a predefined time interval. In one implementation, the risk profiling score assigned to each parameter may be aggregated, in order to derive an aggregated risk profiling score, by the data computation module 214.

At block 510, a category may be identified. In one aspect, the category may be identified based on the aggregated risk profiling score and a predefined range associated with each category. In another aspect, each category may indicate a distinct operational risk profile of the organization. In one implementation, a category, amongst a plurality of predefined categories, may be identified by the identification module 218.

Exemplary embodiments discussed above may provide certain advantages. Though not required to practice aspects of the disclosure, these advantages may include those provided by the following features.

Some embodiments enable a system and a method to enable real time monitoring of the organizational risk.

Some embodiments enable a system and a method to generate an alert associated with the most vulnerable parameter.

Some embodiments enable a system and a method to indicate the risk associated with the operations of the organization.

Some embodiments enable a system and a method to instantaneously update the risk associated with the organization.

Some embodiments enable a system and a method to increase workforce visibility.

Although implementations for methods and systems for indicating an operational risk profile of an organization have been described in language specific to structural features and/or methods, it is to be understood that the appended claims are not necessarily limited to the specific features or methods described. Rather, the specific features and methods are disclosed as examples of implementations for indicating an operational risk profile of an organization.

We claim:

1. A method for indicating an operational risk profile of an organization, the method comprising:
receiving, by a processor (202), an input data corresponding to a set of parameters associated with an operational risk profile of an organization;
computing, by the processor (202), a risk profile value corresponding to each parameter, wherein the risk profile value is computed based on a type of a parameter, of the set of parameters, and the input data pertaining to the parameter;
assigning, by the processor (202), a risk profiling score to the parameter based on comparison of a predefined baseline target value and the risk profile value;
aggregating, by the processor (202), the risk profiling score assigned to each parameter in order to derive an aggregated risk profiling score for the set of parameters, wherein the risk profiling score is aggregated for a predefined time interval; and
identifying, by the processor (202), a category, amongst a plurality of predefined categories, based on the aggregated risk profiling score and a predefined range associated with each category, wherein each category indicates a distinct operational risk profile of the organization.

2. The method of claim 1 further comprises visualizing the aggregated risk profiling score on a User Interface (UI) based on a predefined color code scheme, wherein the predefined color code scheme is based on the predefined range associated with each category.

3. The method of claim 1, wherein the risk profiling score assigned to each parameter is mapped with a color, of plurality of colors, present in the predefined color code scheme.

4. The method of claim 1, wherein the set of parameters comprises at least Service Level Agreements (SLAs) comprising financials and non-financials, sev1 resolution on time, incorrect assignation, backlog index, back-up failures, failed change, human error, customer complaints and Ops.Hi5.

5. A system for indicating an operational risk profile of an organization, the system comprising:
a processor (202); and
a memory (206) coupled to the processor, wherein the processor (202) is capable of executing a plurality of modules (208) stored in the memory (206), and wherein the plurality of modules (208) comprising:
a data receiving module (212) for receiving an input data corresponding to set of parameters associated with an operational risk profile of an organization;
a data computation module (214) for computing a risk profile value corresponding to each parameter, wherein the risk profile value is computed based on a type of a parameter, of the set of parameters, and the input data pertaining to the parameter;
an assignment module (216) for assigning a risk profiling score to the parameter based on comparison of a predefined baseline target value and the risk profile value;
the data computation module (214) for aggregating the risk profiling score assigned to each parameter in order to derive an aggregated risk profiling score, wherein the risk profiling score is aggregated for a predefined time interval; and
an identification module (218) for identifying a category, amongst a plurality of predefined categories, based on the aggregated risk profiling score and a predefined range associated with each category, wherein each category indicates a distinct operational risk profile of the organization.

6. The system of claim 5 further comprises visualizing the aggregated risk profiling score over an interface by using predefined color code scheme, wherein the predefined color code scheme is based on the predefined range associated with each category.

7. The system of claim 5, wherein the risk profiling score assigned to each parameter is mapped with a color, of plurality of colors, present in the predefined color code scheme.

8. The system of claim 5, wherein the set of parameters comprises at least Service Level Agreements (SLAs) comprising financials and non-financials, sev1 resolution on time, incorrect assignation, backlog index, back-up failures, failed change, human error, customer complaints and Ops.Hi5.

9. A non-transitory computer readable medium embodying a program executable in a computing device for indicating an operational risk profile of an organization, the program comprising a program code:
a program code for receiving an input data corresponding to set of parameters associated with an operational risk profile of an organization;
a program code for computing a risk profile value corresponding to each parameter, wherein the risk profile value is computed based on a type of a parameter, of the set of parameters, and the input data pertaining to the parameter;
a program code for assigning a risk profiling score to the parameter based on comparison of a predefined baseline target value and the risk profile value;
a program code for aggregating the risk profiling score assigned to each parameter in order to derive an aggregated risk profiling score, wherein the risk profiling score is aggregated for a predefined time interval; and
a program code for identifying a category, amongst a plurality of predefined categories, based on the aggregated risk profiling score and a predefined range associated with each category, wherein each category indicates a distinct operational risk profile of the organization.
